(19) United States
(12) Patent Application Publication
(10) Pub. No.: US 2025/0306297 A1
(43) Pub. Date: Oct. 2, 2025

(54) PACKAGE WITH OPTICAL CONNECTOR

(71) Applicant: Intel Corporation, Santa Clara, CA (US)

(72) Inventors: Todd COONS, Gilbert, AZ (US); Li YUAN, Fremont, CA (US); Saikumar JAYARAMAN, Chandler, AZ (US); Kumar Abhishek SINGH, Phoenix, AZ (US); Bilas CHOWDHURY, Chandler, AZ (US); Ziyin LIN, Chandler, AZ (US); Shahin MANI, Chandler, AZ (US)

(21) Appl. No.: 18/616,278

(22) Filed: Mar. 26, 2024

(51) Int. Cl. G02B 6/42

(52) U.S. Cl. CPC G02B 6/4206; G02B 6/4268

(57) ABSTRACT

Various aspects may provide a device which may be provided in a package. The device may include a photonic integrated circuit, a lens arrangement, and an optical fiber arrangement. The optical fiber arrangement may optically couple the photonic integrated circuit and the lens arrangement. The lens arrangement may be configured to be optically couplable to an external lens arrangement that is aligned with and spaced apart from the lens arrangement of the device, such that an optical signal is transmissible between the lens arrangement of the device and the external lens arrangement.

### STATEMENT OF GOVERNMENT INTEREST

This Invention was made with Government support under Agreement No. N00164-19-9-0001, awarded by NSWC Crane Division. The Government has certain rights in the Invention.

### BACKGROUND

In the rapidly evolving landscape of semiconductor packaging and integrated systems, the demand for advanced and adaptable signal transmission solutions continues to grow.

Traditional connector solutions often fall short of meeting the requirements of compact semiconductor packages or densely packed devices.

Issues such as size constraints, susceptibility to environmental contaminants, and limitations in signal transmission efficiency underscore a need for an improved connector solution.

As industries increasingly rely on interconnected and miniaturized electronic systems, the pursuit of an improved connector solution becomes ever more imperative.

Recognizing the above, the development of an improved or next-generation connector presents an opportunity to elevate the performance and reliability of signal transmission within semiconductor packages and integrated systems.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. In the following description, various aspects are described with reference to the following drawings, in which:

FIG. 1A is a perspective view of a package, according to various aspects;

FIG. 1B is a side view of the package of FIG. 1A, according to various aspects;

FIG. 1C is a plan view of the package of FIG. 1A, according to various aspects;

FIG. 1D is the bottom view of the package of FIG. 1A, according to various aspects;

FIG. 1E is the front view of the package of FIG. 1A, according to various aspects;

FIG. 2 is a schematic diagram showing an exemplary optical connector for the package of FIG. 1A, according to various aspects;

FIG. 3 is a perspective view of another exemplary optical connector for the package of FIG. 1A, according to various aspects;

FIG. 4A to FIG. 4C are photographs showing various views of a first prototype optical connector, according to various aspects;

FIG. 5A to FIG. 5C are photographs showing various views of a second prototype optical connector, according to various aspects; and

FIG. 6 is a flowchart of depicting a method, according to various aspects.

### DETAILED DESCRIPTION

Aspects described below in the context of the apparatus are analogously valid for the respective methods, and vice versa. Furthermore, it will be understood that the aspects described below may be combined, for example, a part of one aspect may be combined with a part of another aspect.

It should be understood that the terms “on”, “over”, “top”, “bottom”, “down”, “side”, “back”, “left”, “right”, “front”, “lateral”, “side”, “up”, “down” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

Various aspects describe an optical connector, in particular, an expanded beam connector (or an optical connector which utilizes expanded beam), tailored for integration with Photonic Integrated Circuits (PICs) within package assemblies (e.g. semiconductor packages).

According to various aspects, the optical connector may be equipped with at least one lens (e.g. micro lens, also known as microlens or micro-lens) optically attached to an end of an optical fiber (also known as a fiber optic).

The compact size of the optical connector, according to the various aspects, allows for easy integration into package assemblies, ensuring optimal space utilization without compromising performance. By incorporating lens(es) (e.g. micro lens(es)) and optical fiber(s), for optical communication which utilizes expanded beam, the optical connector, according to the various aspects, is capable of establishing robust optical communication links with various optical components and devices. This capability may lead to high-speed data transmission and precise optical sensing within the confined spaces of package environments.

Furthermore, the integration of the optical connector with a PIC, resulting in the creation of a device (e.g. a co-packaged device, semiconductor device, etc.), offers versatility and flexibility, catering to a myriad of applications. Moreover, the device may be easily incorporated into package assemblies.

In the following description, the terms “optical signal”, “optical signals”, and “light” may be used interchangeably.

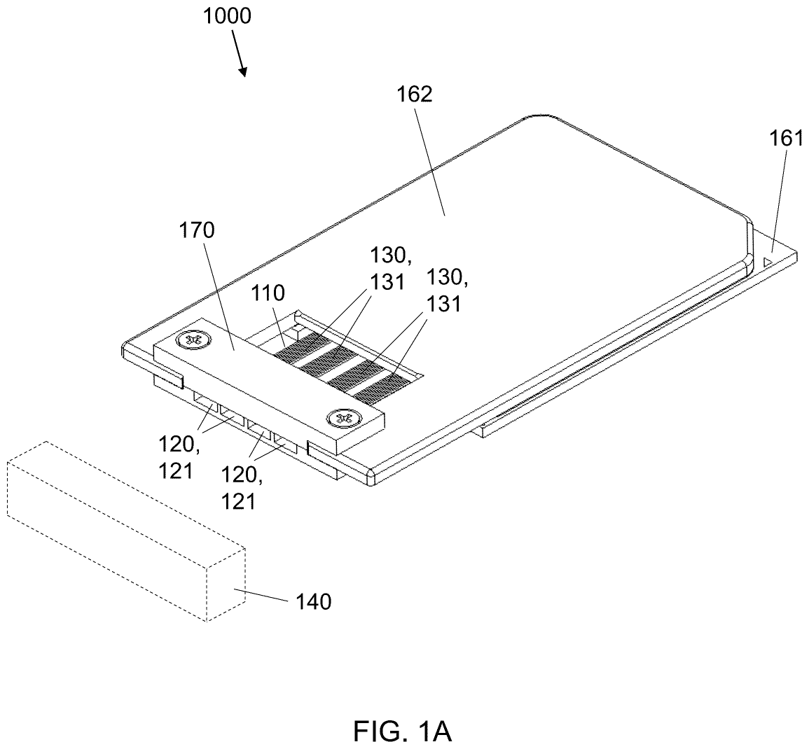

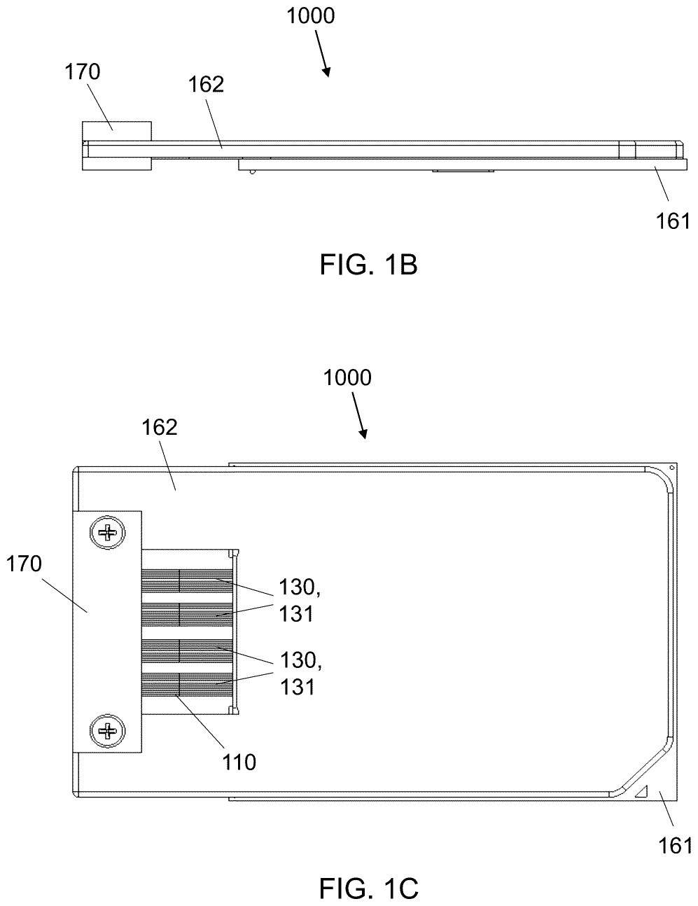

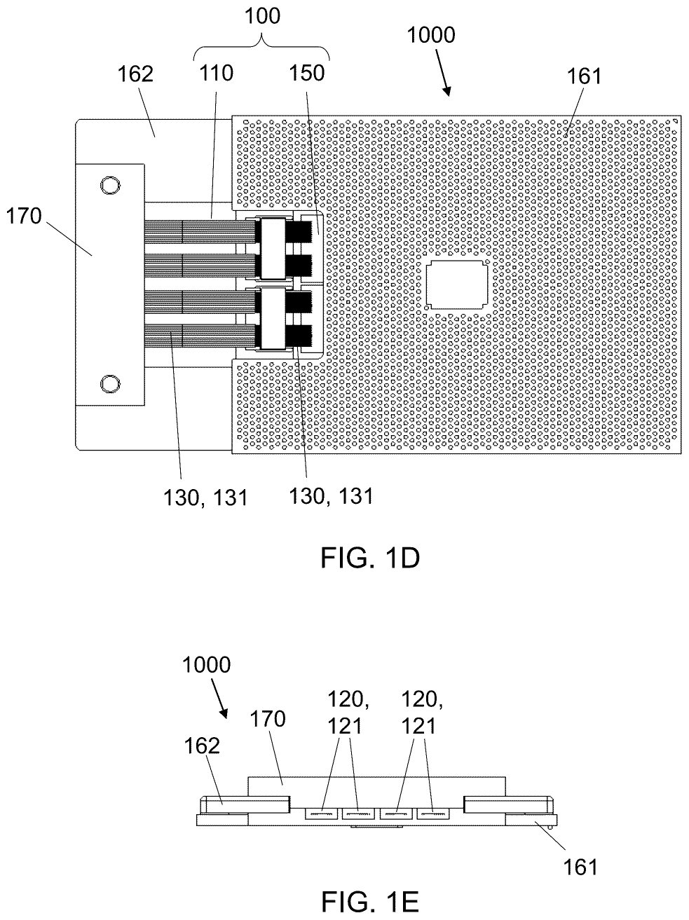

FIG. 1A to FIG. 1E show various view of a package, according to various aspects.

Referring to FIG. 1A to FIG. 1E, according to various aspects, there may be provided an optical connector 110, which may be provided within or integrated into a package 1000 (e.g. a semiconductor package). The optical connector 110 may include at least a lens arrangement (e.g. a micro lens arrangement) 120 (see FIG. 1A and FIG. 1E) as well as an optical fiber arrangement 130 (see FIG. 1A and FIG. 1D). According to various aspects, the optical connector 110 (or at least a component thereof) may be integrated into or within the package 1000. For instance, the optical connector 110 (e.g. its optical fiber arrangement 130) may be optically coupled to at least one component of the package 1000, such as a Photonic Integrated Circuit (PIC) 150, thereby forming a device 100 (e.g. a co-packaged device, semiconductor device, etc.) within the package 1000 (see FIG. 1D). It is envisaged that, in some other aspects, the device 100 may be provided independently of the package 1000.

According to various aspects, the PIC 150, as shown in FIG. 1D, may be configured to transmit (e.g. send) and/or receive optical signals (e.g. electromagnetic waves, for instance, light, which may be used for communication, or any optical signals). According to various aspects, these optical signals may be modulated optical signals or they may be unmodulated optical signals. Additionally, the PIC 150 may be configured to perform or execute one or more optical signal processing functions. As some non-limiting examples, the PIC 150 may be or may include an optical die (e.g. photodetector, laser diode, etc.), an optical transceiver, an optical transmitter, an optical receiver, and/or an optical sensor (e.g. photonic sensor), etc. According to various aspects, the PIC may integrate multiple light-based or photonics components onto a single chip or platform to perform functions related to the generation, manipulation, and/or detection of light. According to various aspects, the PIC 150 may be an integrated PIC 150 (e.g. an integrated optical die) within the package 1000.

According to various aspects, the optical connector 110 may serve to transmit optical signals from the PIC 150 (e.g. to an optical component or device 140, as depicted in FIG. 1A) or to receive optical signals (e.g. from the optical component or the device 140) for subsequent transmission via the optical connector 110 to the PIC 150. This transmission of optical signals, between the optical connector 110 and the optical component 140, may involve the utilization of an expanded beam, achieved with the optical connector 110. Consequently, the optical connector 110 may effectively establish optical communication with the optical component 140, with enhanced signal transmission efficiency and reduced alignment sensitivity.

According to various aspects, the lens arrangement 120 of the optical connector 110 may include one lens (e.g. one micro lens) 121 or a plurality of lenses (e.g. micro lenses) 121. Each lens 121 of the lens arrangement 120 may include a front surface and an opposite rear surface. The rear surface of each lens 121 may be optically coupled to the optical fiber arrangement 130, while the front surface (i.e. opposite the optical fiber arrangement 130) of each lens 121 may be configured to optically communicate (e.g. interface) with an optical component 140, described in detail later.

The optical fiber arrangement 130 of the optical connector 110 may include one optical fiber 131 or a plurality of optical fibers 131 (e.g. bare optical fiber(s) or individual optical fiber strand(s), e.g. without any covering or jacket). According to various aspects, the optical fiber arrangement 130 may include a number of optical fiber(s) 131 equal to a number of lens(es) 121 of the lens arrangement 120. According to various aspects, an end of each optical fiber 131 (e.g. its optical interface or end surface or end face, which allows optical signals to either enter or exit the optical fiber 131) may be optically coupled to the rear surface of a respective lens 121 of the lens arrangement 120. An opposite second end of each optical fiber 131 may be optically coupled (e.g. directly optically coupled, or indirectly optically coupled, e.g. via a waveguide or waveguide assembly) to the PIC 150. Accordingly, within the package 1000 or the device 100, the optical fiber arrangement 130 may be between (e.g. disposed between) the PIC 150 and the lens arrangement 120, thereby optically coupling the PIC 150 and (or to) the lens arrangement 120. In other words, the PIC 150 and the lens arrangement 120 may be optically coupled to each other via the optical fiber arrangement 130, with the optical fiber arrangement 130 between the PIC 150 and the lens arrangement 120.

According to various aspects, the lens arrangement 120 may be configured to collimate optical signals emitted by or originating from the PIC 150 towards a front of the lens arrangement 120. Specifically, these optical signals emitted by the PIC 150 may transmit along the optical fiber arrangement 130 to the lens arrangement 120. As an illustration, the lens arrangement 120 may include at least one collimating lens (e.g. micro collimating lens) configured to collimate the optical signals (i.e. emitted by the PIC 150 and transmitted via the optical fiber arrangement 130 to the lens arrangement 120), as the optical signals pass through the at least one collimating lens from its rear surface (i.e. optically coupled with the optical fiber arrangement 130) to its front surface.

According to various other aspects, the lens arrangement 120 may be configured to focus or concentrate optical signals into the optical fiber arrangement 130, for subsequent transmission via the optical fiber arrangement 130 to the PIC 150. Put differently, these optical signals may be intended for delivery or transmission to the PIC 150 (e.g. originating from an (external) optical component 140 that is optically coupled with the optical connector 110). For instance, the lens arrangement 120 may include at least one focusing lens (e.g. micro focusing lens) configured to focus optical signals into the optical fiber arrangement 130, as the optical signals pass through the at least one collimating lens from its front surface (from which the optical signals enter) to its rear surface (i.e. optically coupled with the optical fiber arrangement 130).

Accordingly, according to various aspects, the lens arrangement 120 (or one or more of its lenses 121) may be configured to collimate or focus optical signals, depending on a direction of the optical signals passing through the lens arrangement 120 (or its one or more lenses 121).

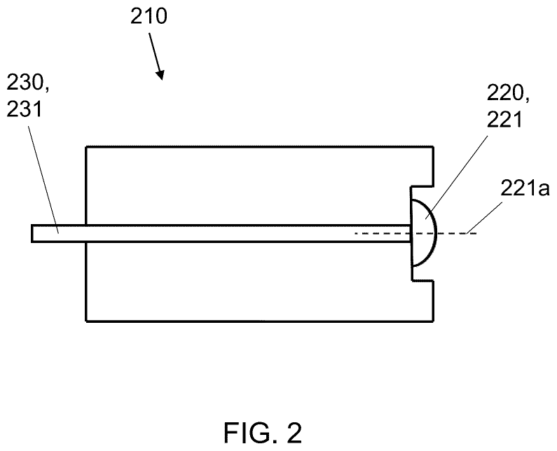

FIG. 2 is a schematic diagram showing an exemplary optical connector for the package of FIG. 1A, according to various aspects.

As shown in FIG. 2, the optical connector 210 may include a lens arrangement (e.g. a micro lens arrangement) 220 having at least one lens (e.g. micro lens) 221 and an optical fiber arrangement 230 having at least one optical fiber 231.

As shown, according to various aspects, the front surface of the lens 221 may include at least one curvature. In other words, the front surface of the lens 221 may be a curved (or substantially curved) front surface. As a non-limiting example, shown in FIG. 2, the front surface of the lens 221 may be a convex-shaped front surface. It is envisaged that, in some other aspects (not shown), the lens 221, including its front surface or any surface thereof for optical signals to enter or exit the lens 221, may adopt any other shape or profile having at least one curvature. For instance, in some other aspects (not shown), the lens 221 may be a prism (e.g. a right-angle prism and/or a micro prism), having a rear surface and a curved base surface (or a curved roof surface), which may be substantially perpendicular to each other, as well as an angled (or inclined or slopping) surface (e.g. a planar surface) extending between the rear surface and the curved base surface (or curved roof surface). In this configuration, while the angled surface of the prism may be facing a front of the optical connector 210, optical signals may enter or exit the prism via the curved base surface (or curved roof surface) of the prism. As an example, the curved base surface (or curved roof surface) of the prism may be a convex-shaped base surface (or convex-shaped curved roof surface). The sloping surface of the prism may serve to internally reflect optical signals between the rear surface and the curved base surface (or curved roof surface) of the prism.

According to various aspects, the rear surface of the lens 221 may be configured (e.g. shaped, dimensioned, etc.) to facilitate alignment with a respective optical fiber 231 of the optical fiber arrangement 230. As a non-limiting example, shown in FIG. 2, the rear surface of the lens 221 may be a flat or planar (e.g. a substantially flat or substantially planar) rear surface (e.g. perpendicular or substantially perpendicular to a principal axis 221a of the lens 221). Consequently, an optical interface (e.g. an end surface or end face) of the optical fiber 231 may be optically coupled (e.g. directly optically coupled) to the rear surface of the lens 221. Accordingly, optical signals may be transmissible (e.g. directly transmissible) from the optical fiber 231 to the lens 221 or from the lens 221 to the optical fiber 231, depending on a direction of the optical signal being transmitted. According to various aspects, the optical interface of the optical fiber 231 may be in direct (e.g. physical) contact with the rear surface of the lens 221. According to various aspects, the optical fiber 231 may be affixed to (e.g. immovably fixed to), bonded to (e.g. integrally bonded), or integrated with the lens 221. According to various aspects, the lens 221 may be integrally formed at an end (e.g. at the optical interface) of the optical fiber 231. Accordingly, in some aspects, the optical fiber 231 and the lens 221 may be a unified entity or structure. As some non-limiting examples, bonding techniques for attaching or coupling the lens 221 to the end of the optical fiber 231 may include thermal bonding, epoxy bonding, splicing (e.g. fusion splicing), fusion bonding, surface activation bonding, etc., or any other suitable bonding techniques.

With reference to FIG. 2, as an illustration, light (e.g. divergent light), emitted from the end surface of the optical fiber 231, may undergo collimation by the lens 221. Accordingly, light (or light rays) exiting the front surface of the lens 221 may be collimated, in other words, become parallel or substantially parallel, thereby expanding a size (or a diameter) of the light (e.g. light beam) as it emerges from the front surface of the lens 221. Specifically, according to various aspects, the lens 221 may be configured to refract light, incoming from its rear surface (i.e. which is optically coupled to the optical fiber 231) in such a manner that the light becomes collimated upon emerging from its front surface. In other words, optical signals that enter the lens 221 from its rear surface may have an enlarged size (e.g. a larger diameter) upon exiting from the front surface of the lens 221. According to various aspects, this configuration of the optical connector 210 may facilitate and improve alignment for optical transmission to a subsequent optical component (e.g. optical component 140, as depicted in FIG. 1A), which may include an external or corresponding lens arrangement (e.g. an external or corresponding micro lens arrangement) for receiving the collimated light.

As another illustration, light entering the front surface of the lens 221 of the optical connector 210 may be directed by the lens 221 into the optical fiber 231 (i.e. that is situated at the rear surface of the lens 221). In other words, light may be focused or concentrated onto the optical fiber 231 at the rear surface of the lens 221. In this arrangement, optical signals (e.g. light) entering the lens 221 from its front surface may exit from the rear surface of the lens 221 with a reduced or decreased size (e.g. a smaller diameter).

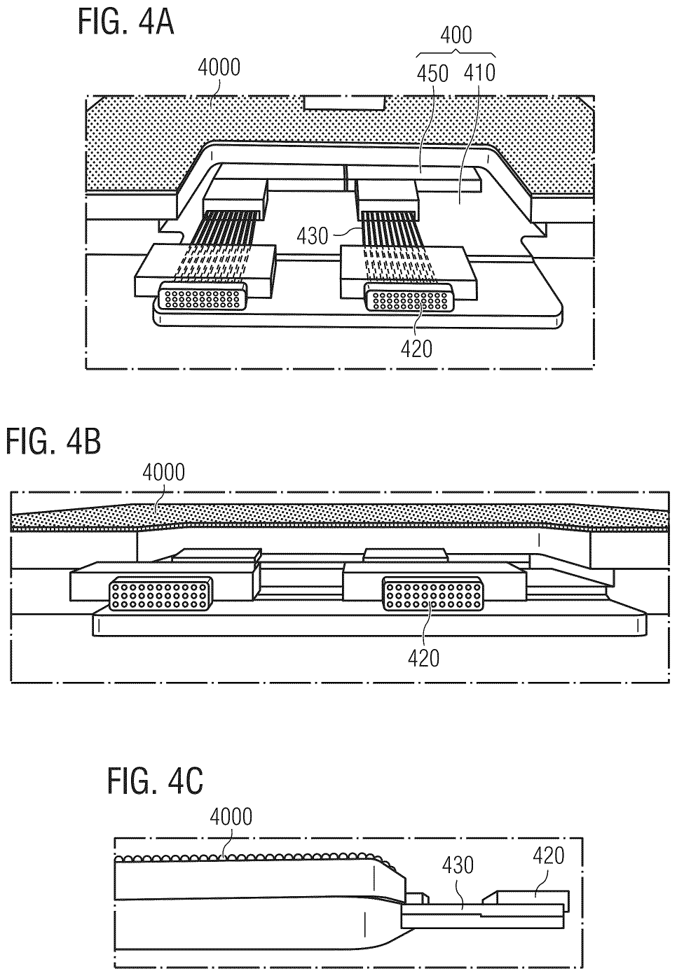

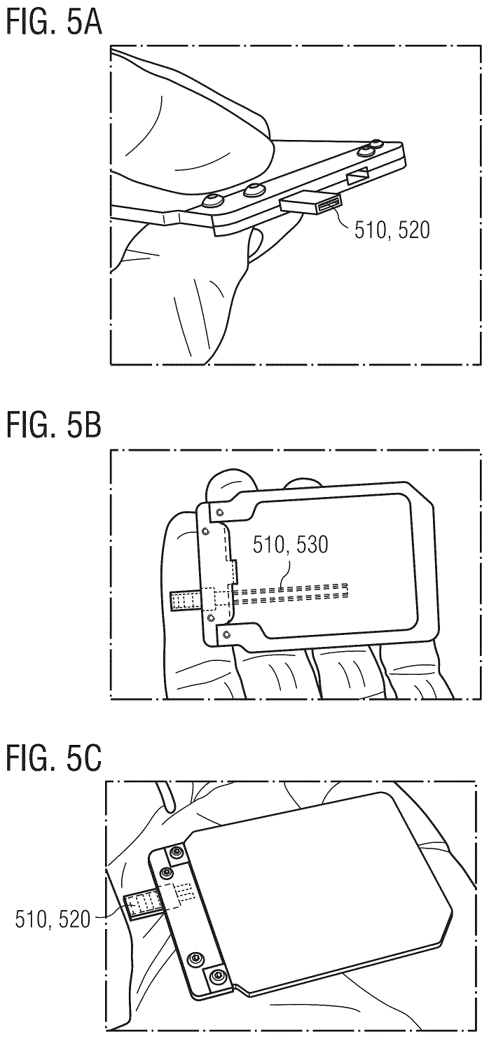

Referring back to FIG. 1A and FIG. 1E, according to various aspects, the lens arrangement 120 may be located at or proximal to an edge of the package 1000. According to various other aspects, the lens arrangement 120 (e.g. including a portion of the optical fiber arrangement 130) may be extending outwardly from an edge of the package 1000 (see, for example, lens arrangement 420 in FIG. 4C or lens arrangement 520 in FIG. 5C). According to various aspects, the package 1000 may include a housing 170 (e.g. a holding bracket, a mounting frame, etc.) to hold and/or secure the optical connector 110 (e.g. at least the lens arrangement 120 and/or the optical fiber arrangement 130) at a fixed location relative to other components within the package 1000. According to various aspects, the housing 170 may provide alignment features (e.g. gross alignment features) for aligning the lens arrangement 120 of the optical connector 110 with an external or corresponding lens arrangement (e.g. of an (external) optical component 140). Furthermore, according to various aspects, the housing 170 may include one or more reinforcing or support structures which may prevent or minimize any risk of damage to the PIC 150 within the package 1000. According to various aspects, the housing 170 may be composed of a material possessing at least one or more of the following properties: high hardness, high rigidity, and/or high thermal stability/resistance. As some non-limiting examples, the housing 170 may be composed of glass or polymer (e.g. a hard and/or rigid and/or highly thermal resistant polymer).

According to various aspects, such a positioning of the lens arrangement 120 within the package 1000 may facilitate optical coupling of the lens arrangement 120 of the package 1000 with an external or corresponding lens arrangement.

According to various aspects, as a non-limiting example, the external or corresponding lens arrangement may be part of a jumper cable (e.g. configured for optical connection or communication with the optical connector 110 of the package 1000, utilizing an expanded beam for the optical connection or communication). Accordingly, according to various aspects, the lens arrangement 120 of the package 1000 may be capable of optical coupling (in other words, may be optically couplable) to the external or corresponding lens arrangement, while the external or corresponding lens arrangement is aligned with and spaced apart (e.g. by a gap, air gap, etc.) from the lens arrangement 120 of the package 1000. In this configuration, an optical signal (or optical signals) may be transmissible, over the spacing or gap, between the lens arrangement 120 of the package 1000 (or the device 100) and the external or corresponding lens arrangement which are aligned.

Accordingly, according to various other aspects, the lens arrangement 120 (referred to as a “first lens arrangement”) and the external or corresponding lens arrangement (referred to as a “second lens arrangement”) may together form or be part of the optical connector 110. For instance, the first lens arrangement may belong to a first section (e.g. a “male” section) of such an optical connector 110, while the second lens arrangement may belong to a second section (e.g. a “female” section) of such an optical connector 110. According to various other aspects, the package 1000 (or the device 100) may include such an optical connector 110 (e.g. having both the male and female sections).

According to various aspects, the package 1000 may include (e.g. further/optionally include) a substrate 161 (e.g. a semiconductor substrate). Within the package 1000, the PIC 150 may be on (e.g. disposed directly on) the substrate 161.

According to various aspects, the package 1000 may include (e.g. further/optionally include) a heat spreader 162 thermally coupled to and/or in contact with the PIC 150. In particular, within the package 1000, the heat spreader 162 may be attached to the PIC 150 and may be configured to manage and dissipate heat generated by the PIC 150 during operation.

As an example, shown in FIG. 1D, according to various aspects, within the package 1000, the PIC 150 and the optical fiber arrangement 130 (i.e. optically coupled to the PIC 150 and the lens arrangement 120) may be on a same side (or surface) of the heat spreader 162.

Furthermore, as an example, with reference to FIG. 1C and FIG. 1D, the housing 170 may be coupled (e.g. removably coupled) to the heat spreader 162 (e.g. using one or more fasteners, such as screw(s), bolt(s) and nut(s), etc., or an adhesive). It is envisaged that, in some other aspects, the housing 170 may be coupled or affixed to the heat spreader 162 and/or to the substrate 161.

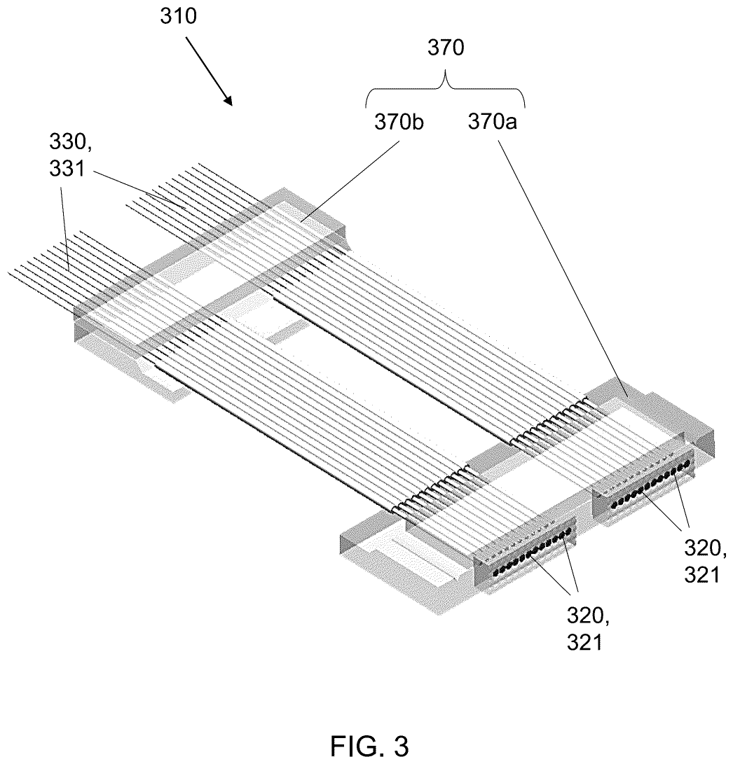

FIG. 3 is a perspective view of another exemplary optical connector for the package of FIG. 1A, according to various aspects.

As shown in FIG. 3, the optical connector 310 may include a lens arrangement (e.g. a micro lens arrangement) 320 having a plurality of lenses (e.g. micro lenses) 321 and an optical fiber arrangement 330 having a plurality of optical fibers 331. The plurality of optical fibers 331 may be optically coupled or bonded to the plurality of lenses 321, respectively, to form the optical connector 310.

With reference to FIG. 3, according to various aspects, the plurality of optical fibers 331 may be arranged according to an array (e.g. an orderly pattern or arrangement). According to various aspects, such an array of optical fibers 331 may together form, may be part of, or may be referred to as a Fiber Array Unit (FAU). As an example, shown in FIG. 3, the plurality of optical fibers 331 may be extending linearly, and these linearly extending optical fibers 331 may be arranged parallel with one another. Additionally, according to various aspects, the plurality of optical fibers 331 may be arranged adjacent to one another, in orderly row(s) and/or column(s). It is envisaged that, in some other aspects (not shown), the plurality of optical fibers 331 (or sub-sets of optical fibers 331 of the optical fiber arrangement 330) may be extending linearly, but at least a pair of optical fibers 331 (or at least two different sub-sets of optical fibers 331 of the optical fiber arrangement 330) may be non-parallel to each other. Furthermore, in some other aspects (not shown), any one or more optical fibers 331 (or at least a sub-set of optical fibers 331 of the optical fiber arrangement 330) may be extending in a non-linear manner (e.g. having or forming at least one curve, bend, corner, etc.).

As an example, shown in FIG. 3, the optical fiber arrangement 330 or the FAU may include “24” (e.g. “24” discrete or individual strands of) optical fibers 331. Furthermore, according to various aspects, the optical fiber arrangement 330 or the FAU may be divided into a plurality of sub-sets of optical fibers 331. As an example, shown in FIG. 3, the optical fiber arrangement 330 or the FAU may be divided into “2” sub-sets (e.g. of “12” optical fibers 331 in each sub-set).

According to various aspects, one end of the optical fiber arrangement 330 (or of each optical fiber 331 thereof) may be optically coupled (e.g. directly optically coupled, or indirectly optically coupled, e.g. via a waveguide or waveguide assembly) to a PIC, such as the PIC 150 of the package 1000 shown in FIG. 1D. According to various other aspects, different sub-sets of optical fibers 331 within the optical fiber arrangement 330 or a FAU may be optically coupled to different optical components (e.g. to respective or discrete PICs).

Another end of the optical fiber arrangement 330 (or of each optical fiber 331 thereof) may be optically coupled or bonded to the lens arrangement 320. According to various aspects, the lens arrangement 320 may include a plurality of lenses 321 equal to a number of optical fibers 331 of the optical fiber arrangement 330. Thus, as an example, the optical connector 310 may include “24” (e.g. “24” discrete or individual pieces) of lenses 321, and each lens 321 (e.g. its rear surface) may be optically coupled with or bonded to a respective optical fiber 331 of the optical fiber arrangement 330. As shown, similar to the FAU, the plurality of lenses 321 may be arranged according to an array (e.g. corresponding to the FAU).

Additionally, as shown in FIG. 3, according to various aspects, there may be provided a housing (e.g. a “multi-unit” housing) 370 for the optical connector 310. As a non-limiting example, shown in FIG. 3, the housing 370 may include a first part (e.g. a first unit) 370a and a second part (e.g. a second unit) 370b. According to various aspects, the first part (e.g. first unit) 370a of the housing 370 may be configured to hold the plurality of lenses 321 and at least a segment of the plurality of optical fibers 331, while the second part (e.g. second unit) 370b of the housing 370 may be configured to hold another segment of the plurality of optical fibers 331.

FIG. 4A to FIG. 4C are photographs showing various views of a first prototype optical connector, according to various aspects.

According to various aspects, the optical connector 410 may be a prototype (e.g. a partial or full prototype) of the optical connector 310 of FIG. 3.

As shown, the optical connector 410 may include a lens arrangement (e.g. a micro lens arrangement) 420, which may be similar or identical to the lens arrangement 320 of FIG. 3.

As shown, the optical connector 410 may further include an optical fiber arrangement 430, which may be similar or identical to the optical fiber arrangement 330 of FIG. 3.

As shown, the optical connector 410, in particular, its optical fiber arrangement 430, may be optically coupled with a PIC 450 to form a device 400 (e.g. a co-packaged device, semiconductor device, etc.).

According to various aspects, the device 400 may be provided within a package 4000.

FIG. 5A to FIG. 5C are photographs showing various views of a second prototype optical connector, according to various aspects.

According to various aspects, the optical connector 510 may be a prototype (e.g. a partial or full prototype) of the optical connector 110 of FIG. 1A to FIG. 1E, the optical connector 210 of FIG. 2, or the optical connector 310 of FIG. 3.

As shown, the optical connector 510 may include a lens arrangement (e.g. a micro lens arrangement) 520, which may be similar or identical to the lens arrangement 120 of FIG. 1A to FIG. 1E, the lens arrangement 220 of FIG. 2, or the lens arrangement 320 of FIG. 3.

As shown, the optical connector 510 may further include an optical fiber arrangement 530, which may be similar or identical to the optical fiber arrangement 130 of FIG. 1A to FIG. 1E, the optical fiber arrangement 230 of FIG. 2, or the optical fiber arrangement 330 of FIG. 3. s

According to various aspects, the optical connector 510, in particular, its optical fiber arrangement 530, may be optically coupled with a PIC to form a device (e.g. a co-packaged device, semiconductor device, etc.). According to various aspects, this device may be provided within a package.

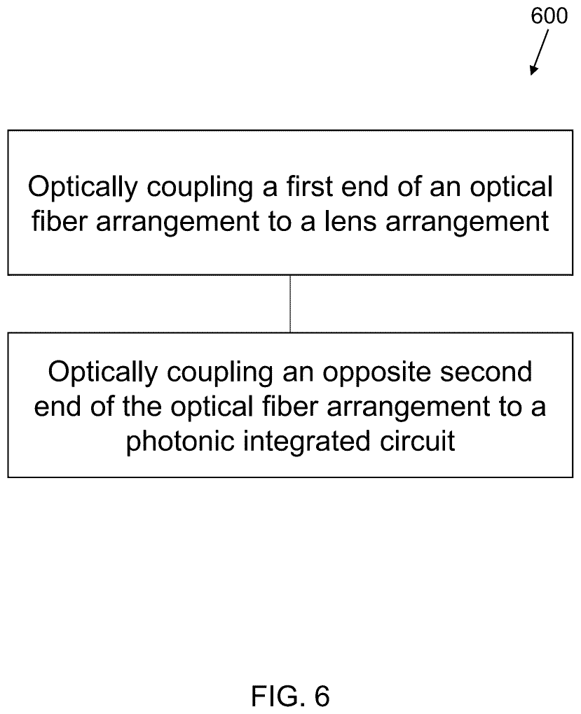

FIG. 6 is a flowchart depicting a method, according to various aspects.

According to various aspects, there may be provided a method 600. According to various aspects, the method 600 may be a method of assembling or forming the device 100 or 400 and/or the package 1000 or 4000 and/or of operating the package 1000 or 4000 (or one or more of its components, such as the device 100 or 400).

According to various aspects, the method 600 may include optically coupling a first end of the optical fiber arrangement 130, 230, 330, 430, or 530 to the lens arrangement 120, 220, 320, 420, or 520, to form the optical connector 110, 210, 310, 410, or 510. Specifically, the method 600 may include optically coupling a first end of each optical fiber of the optical fiber arrangement 130, 230, 330, 430, or 530 to a respective (or discrete) lens (e.g. micro lens) of the lens arrangement 120, 220, 320, 420, or 520.

The method 600 may further include optically coupling a second end (e.g. opposite the first end) of the optical fiber arrangement 130, 230, 330, 430, or 530 to the PIC 150 or 450, to form the device 100 or 400 (e.g. a co-packaged device, semiconductor device, etc.). Specifically, the method 600 may include optically coupling a second end of each optical fiber of the optical fiber arrangement 130, 230, 330, 430, or 530 to the PIC 150 or 450 (e.g. to an input/output port, or an interface point, of the PIC 150 or 450).

The method 600 may further include providing the substrate 161 (e.g. semiconductor substrate).

The method 600 may further include disposing (e.g. attaching or mounting) the PIC 150 or 450 on (e.g. directly or indirectly on) the substrate 161.

The method 600 may further include attaching the heat spreader 162 to the PIC 150 or 450. The heat spreader 162 may be engaged or in contact (e.g. direct contact, or indirect thermal connection with) the PIC 150 or 450.

The method 600 may further include coupling (e.g. directly or indirectly coupling) the housing 170 or 370 to the heat spreader 162. The housing 170 or 370 may be housing or holding at least the lens arrangement 120, 220, 320, 420, or 520.

The method 600 may further include optically coupling a further lens arrangement or further micro lens arrangement (e.g. belonging to a corresponding “male” section or “female” section of the optical connector or to an optical component 140) to the lens arrangement 120, 220, 320, 420, or 520, in a manner such that the further lens arrangement is aligned with and spaced apart from the lens arrangement 120, 220, 320, 420, or 520.

According to various aspects, the method 600 may further include operating the PIC 150 or 450 (e.g. to transmit or to receive/sense optical signals).

While the disclosure has been particularly shown and described with reference to specific aspects, it should be understood by those skilled in the art that various changes, modification, variation in form and detail may be made therein without departing from the scope of the present disclosure as defined by the appended claims. The scope of the present disclosure is thus indicated by the appended claims and all changes which come within the meaning and range of equivalency of the claims are therefore intended to be embraced.

To more readily understand and put into practical effect the present device, package, and method, they will now be described by way of examples. For the sake of brevity, duplicate descriptions of features and properties may be omitted.

### EXAMPLES

Example 1 provides a device (e.g. a semiconductor device). The device may include a photonic integrated circuit, a lens arrangement, and an optical fiber arrangement optically coupling the photonic integrated circuit and the lens arrangement. In particular, the photonic integrated circuit and the lens arrangement may be optically coupled to each other via the optical fiber arrangement, with the optical fiber arrangement between the photonic integrated circuit and the lens arrangement. The lens arrangement may be configured to be optically couplable to an external lens arrangement that is aligned with and spaced apart from the lens arrangement of the device, such that an optical signal may be transmissible between the lens arrangement of the device and the external lens arrangement.

Example 2 may include the device of example 1 and/or any other example disclosed herein, for which, the lens arrangement may include a plurality of micro lenses.

Example 3 may include the device of example 1 and/or any other example disclosed herein, for which, the lens arrangement may include at least one prism.

Example 4 may include the device of example 1 and/or any other example disclosed herein, for which, the lens arrangement may include at least one micro lens and, for which, a surface of the at least one micro lens, that is opposite the optical fiber arrangement, may include a curvature (e.g. at least one curvature).

Example 5 may include the device of example 1 and/or any other example disclosed herein, for which, the lens arrangement may include at least one collimating lens configured to collimate the optical signal passing through the at least one collimating lens and, for which, the optical signal may be emitted by the photonic integrated circuit and transmitted to the at least one collimating lens via the optical fiber arrangement.

Example 6 may include the device of example 1 and/or any other example disclosed herein, for which, the lens arrangement may include at least one focusing lens configured to focus the optical signal, received by the at least one focusing lens, into the optical fiber arrangement and, for which, the optical signal may be transmitted from the at least one focusing lens to the photonic integrated circuit via the optical fiber arrangement.

Example 7 may include the device of example 1 and/or any other example disclosed herein, for which, the optical fiber arrangement may include a plurality of optical fibers.

Example 8 may include the device of example 7, for which, the plurality of optical fibers may be parallel (e.g. arranged parallel) to one another.

Example 9 may include the device of example 1 and/or any other example disclosed herein, for which, the photonic integrated circuit may include an optical die.

Example 10 provides a package (e.g. a semiconductor package). The package may include a semiconductor substrate, a photonic integrated circuit on the semiconductor substrate, and an optical connector. The optical connector may include a lens arrangement and an optical fiber arrangement optically coupling the lens arrangement with (or and or to) the photonic integrated circuit. In particular, the photonic integrated circuit and the lens arrangement may be optically coupled to each other via the optical fiber arrangement, with the optical fiber arrangement between the photonic integrated circuit and the lens arrangement.

Example 11 may include the package of example 10 and/or any other example disclosed herein, for which, the optical connector may further include a further lens arrangement optically coupled to the lens arrangement in a manner such that the further lens arrangement may be aligned with the lens arrangement and may be spaced apart from the lens arrangement (e.g. by a spacing or a gap), for which, an optical signal may be transmissible between the lens arrangement and the further lens arrangement (e.g. across the spacing or gap).

Example 12 may include the package of example 10 and/or any other example disclosed herein, for which, the lens arrangement may include at least one collimating lens configured to collimate an optical signal passing through the at least one collimating lens and, for which, the optical signal may be emitted by the photonic integrated circuit and transmitted to the at least one collimating lens via the optical fiber arrangement.

Example 13 may include the package of example 10 and/or any other example disclosed herein, for which, the lens arrangement may include at least one focusing lens configured to focus an optical signal, received by the at least one focusing lens, into the optical fiber arrangement and, for which, the optical signal may be transmitted from the at least one focusing lens to the photonic integrated circuit via the optical fiber arrangement.

Example 14 may include the package of example 10 and/or any other example disclosed herein, for which, the package may further include a heat spreader thermally coupled to the photonic integrated circuit.

Example 15 may include the package of example 14, for which, the package may further include a housing coupled to the heat spreader, for which, the housing may be configured to hold (e.g. hold at least) the lens arrangement.

Example 16 provides a method. The method may include optically coupling a first end of an optical fiber arrangement to a lens arrangement. The method may further include optically coupling an opposite second end of the optical fiber arrangement to a photonic integrated circuit.

Example 17 may include the method of example 16 and/or any other example disclosed herein, for which, the method may further include providing a semiconductor substrate, and disposing the photonic integrated circuit on the semiconductor substrate.

Example 18 may include the method of example 16 and/or any other example disclosed herein, for which, the method may further include attaching a heat spreader to the photonic integrated circuit.

Example 19 may include the method of example 18, for which, the method may further include coupling a housing to the heat spreader, with the housing holding the lens arrangement.

Example 20 may include the method of example 16 and/or any other example disclosed herein, for which, the method may further include optically coupling a further lens arrangement to the lens arrangement, in a manner such that the further lens arrangement is aligned with the lens arrangement and is spaced apart from the lens arrangement.

1. A device comprising:
a photonic integrated circuit;
a lens arrangement; and
an optical fiber arrangement;
wherein the photonic integrated circuit and the lens arrangement are optically coupled to each other via the optical fiber arrangement, with the optical fiber arrangement between the photonic integrated circuit and the lens arrangement.

2. The device of claim 1,
wherein the lens arrangement comprises a plurality of micro lenses.

3. The device of claim 1,
wherein the lens arrangement comprises at least one prism.

4. The device of claim 1,
wherein the lens arrangement comprises at least one micro lens;
wherein a surface of the at least one micro lens, that is opposite the optical fiber arrangement, comprises a curvature.

5. The device of claim 1,
wherein the lens arrangement comprises at least one collimating lens configured to collimate the optical signal passing through the at least one collimating lens;
wherein the optical signal is emitted by the photonic integrated circuit and transmitted to the at least one collimating lens via the optical fiber arrangement.

6. The device of claim 1,
wherein the lens arrangement comprises at least one focusing lens configured to focus the optical signal, received by the at least one focusing lens, into the optical fiber arrangement;
wherein the optical signal is transmitted from the at least one focusing lens to the photonic integrated circuit via the optical fiber arrangement.

7. The device of claim 1,
wherein the optical fiber arrangement comprises a plurality of optical fibers.

8. The device of claim 7,
wherein the plurality of optical fibers are arranged parallel to one another.

9. The device of claim 1,
wherein the photonic integrated circuit comprises an optical die.

10. A package comprising:
a semiconductor substrate;
a photonic integrated circuit on the semiconductor substrate;
an optical connector comprising:
a lens arrangement; and
an optical fiber arrangement;
wherein the photonic integrated circuit and the lens arrangement are optically coupled to each other via the optical fiber arrangement, with the optical fiber arrangement between the photonic integrated circuit and the lens arrangement.

11. The package of claim 10,
wherein the optical connector further comprises:
a further lens arrangement optically coupled to the lens arrangement in a manner such that the further lens arrangement is aligned with the lens arrangement and is spaced apart from the lens arrangement;
wherein an optical signal is transmissible between the lens arrangement and the further lens arrangement.

12. The package of claim 10,
wherein the lens arrangement comprises at least one collimating lens configured to collimate an optical signal passing through the at least one collimating lens;
wherein the optical signal is emitted by the photonic integrated circuit and transmitted to the at least one collimating lens via the optical fiber arrangement.

13. The package of claim 10,
wherein the lens arrangement comprises at least one focusing lens configured to focus an optical signal, received by the at least one focusing lens, into the optical fiber arrangement;
wherein the optical signal is transmitted from the at least one focusing lens to the photonic integrated circuit via the optical fiber arrangement.

14. The package of claim 10, further comprising:
a heat spreader thermally coupled to the photonic integrated circuit.

15. The package of claim 14, further comprising:
a housing coupled to the heat spreader, wherein the housing is configured to hold the lens arrangement.

16. A method comprising:
optically coupling a first end of an optical fiber arrangement to a lens arrangement; and
optically coupling an opposite second end of the optical fiber arrangement to a photonic integrated circuit.

17. The method of claim 16, further comprising:
providing a semiconductor substrate; and
disposing the photonic integrated circuit on the semiconductor substrate.

18. The method of claim 16, further comprising:
attaching a heat spreader to the photonic integrated circuit.

19. The method of claim 18, further comprising:
coupling a housing to the heat spreader, with the housing holding the lens arrangement.

20. The method of claim 16, further comprising:
optically coupling a further lens arrangement to the lens arrangement, in a manner such that the further lens arrangement is aligned with the lens arrangement and is spaced apart from the lens arrangement.
